(19) United States
(12) Patent Application Publication
(10) Pub. No.: US 2005/0160817 A1
(43) Pub. Date: Jul. 28, 2005

(54) Superresolution ultrasound

(76) Inventors: Gregory T. Clement, Boston, MA (US); Kullvero H. Hynynen, Medfield, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/910,841

(22) Filed: Aug. 4, 2004

Related U.S. Application Data
(60) Provisional application No. 60/492,463, filed on Aug. 4, 2003.

(51) Int. Cl. G01H 17/00; G01N 24/00

(52) U.S. Cl. 73/570

(57) ABSTRACT

A computer program product resides on a computer-readable medium and comprises computer-readable, computer-executable instructions for causing a computer to transmit first indicia for an ultrasound propagation arrangement to propagate ultrasound energy toward a focal region containing an object, receive second indicia from a receiver positioned to receive the propagated ultrasound energy after passing at least one of by and through the object and configured to transduce the received ultrasound energy into the second indicia, analyze the second indicia to determine magnitude and phase of the received ultrasound energy, and use the determined magnitude and phase of the received ultrasound energy and knowledge of the ultrasound energy propagated from the propagation arrangement to mathematically propagate indicia of at least one of the received ultrasound energy and the transmitted ultrasound energy to a common location.

### CROSS-REFERENCE TO RELATED ACTIONS

This application claims the benefit of U.S. Provisional Application No. 60/492,463 filed Aug. 4, 2003, which is incorporated here by reference in its entirety.

### STATEMENT AS TO FEDERALLY-SPONSORED RESEARCH

This invention was made at least in part with Government support under Grant No. CA46627, awarded by The National Institutes of Health. The Government has certain rights in this invention.

### BACKGROUND

Over the past decade, sub-millimeter imaging in vivo has been a goal of numerous imaging modalities in biological and medical imaging, motivated by the considerable amount of potential uses in diagnostics and in the study of biological models. Some of these uses include, but are not limited to, sensing tissue morphological changes, monitoring of disease progression, temperature monitoring, following mouse and chicken embryonic development for genomics and other areas, and monitoring of the vascular system. High-resolution optics, nuclear magnetic resonance (NMR), X-Ray computed tomography (CT) and Ultrasound have all been examined as methods for performing high-resolution imaging, each with their own unique advantages and disadvantages.

Optical coherence tomography (OCT) has been used to perform in vivo imaging of tissue interiors in a manner analogous to B-scan ultrasound by using infrared or near infrared light interferometry. Resolution of less than 1 micron has been achieved, but with a penetration depth of only a few millimeters. Magnetic Resonance Microscopy (μMRI) and CT Microscopy have both demonstrated significant progress in high-resolution imaging with deep penetration. The cost and large apparatus involved with these methods, however, make them impractical for laboratory or small clinical use.

In ultrasound, two basic high-resolution approaches have been applied: Ultrasound Micro-imaging (UMI) and Ultrasound biomicroscopy (UBM). These techniques have been used for their ability to measure a number of tissue properties that are not readily obtainable with other methods. These properties include ultrasound speed, attenuation and impedance, and stiffness and temperature sensitivity. On a practical level, ultrasound has been considered an attractive alternative to other methods due to its potential for producing a compact, non-ionizing, and very low cost imaging device that could be utilized in a clinical or laboratory setting. The traditional approach applied in both UMI and UBM has been to image higher ultrasound frequencies. Using these methods, image resolution has been extended to about 10 microns, but with the tradeoff of significantly increased attenuation.

### SUMMARY

In general, in an aspect, the invention provides a computer program product residing on a computer-readable medium and comprising computer-readable, computer-executable instructions for causing a computer to transmit first indicia for an ultrasound propagation arrangement to propagate ultrasound energy toward a focal region containing an object, receive second indicia from a receiver positioned to receive the propagated ultrasound energy after passing at least one of by and through the object and configured to transduce the received ultrasound energy into the second indicia, analyze the second indicia to determine magnitude and phase of the received ultrasound energy, and use the determined magnitude and phase of the received ultrasound energy and knowledge of the ultrasound energy propagated from the propagation arrangement to mathematically propagate indicia of at least one of the received ultrasound energy and the transmitted ultrasound energy to a common location.

Implementations of the invention may include one or more of the following features. The computer program product further includes instructions for causing the computer to produce a perturbed signal indicative of the transmitted ultrasound energy perturbed by an estimate of the object, wherein the instructions for causing the computer to propagate indicia are configured to cause the computer to propagate indicia of at least one of the perturbed signal and the received ultrasound energy to a common plane. The instructions for causing the computer to propagate indicia are configured to cause the computer to back-propagate the indicia of the received ultrasound energy to a plane of the focal region and object. The computer program product further includes instructions for causing the computer to determine a shape of the object using the indicia of the back-propagated ultrasound energy. The instructions for causing the computer to determine the shape comprise instructions for causing the computer to compare third indicia of the back-propagated ultrasound energy at the plane with fourth indicia of the perturbed signal, and iterate the estimate of the object until a relationship between the third indicia and the fourth indicia meets at least one criterion. The computer program product further includes instructions for causing the computer to produce an image using the estimate of the object when the at least one criterion is met. The computer program product further includes instructions for causing the computer to alter the propagated ultrasound energy in at least one of phase, magnitude, and space.

Implementations of the invention may also include one or more of the following features. The computer program product further includes instructions for causing the computer to cause the input beam to be moved. The instructions for causing the computer to cause the input beam to be moved cause the input beam to be electronically scanned. The instructions for causing the computer to cause the input beam to be moved cause at least a portion of the ultrasound propagation arrangement to be moved around the object. The computer program product further includes instructions for causing the computer to produce a three-dimensional image of the object using data with the at least a portion of the ultrasound propagation arrangement in different positions with respect to the object.

In general, in another aspect, the invention provides a method of imaging an object, the method including transmitting first indicia for an ultrasound propagation arrangement to send ultrasound energy toward a focal region containing an object, receiving second indicia from a receiver positioned to receive the propagated ultrasound energy after passing at least one of by and through the object and configured to transduce the received ultrasound energy into the second indicia, analyzing the second indicia to determine magnitude and phase of the received ultrasound energy, and using at least one of the determined magnitude and phase of the received ultrasound energy and knowledge of the sent ultrasound energy to mathematically propagate at least one of third indicia of the received ultrasound energy and fourth indicia of the sent ultrasound energy to a common location for comparison of at least one of the received ultrasound energy and the third indicia with at least one of the sent ultrasound energy and the fourth indicia.

Implementations of the invention may include one or more of the following features. The third indicia are back-propagated to a plane of the focal region and object. The method further includes determining a shape of the object using the back-propagated third indicia and knowledge of the ultrasound energy sent from the propagation arrangement. Determining the shape includes comparing the third indicia of the back-propagated ultrasound energy at the plane with the fourth indicia of the propagated ultrasound energy at the plane of the focal region unperturbed by the object, and iterating an estimate of the object until a relationship between the third indicia and the fourth indicia meets at least one criterion. The method further includes producing an image using the estimate of the object when the at least one criterion is met.

Implementations of the invention may also include one or more of the following features. The method further includes altering the propagated ultrasound energy in at least one of phase, magnitude, and space. The method further includes moving the input beam. Moving the input beam comprises electronically scanning the input beam. Moving the input beam comprises moving at least a portion of the ultrasound propagation arrangement around the object. The method further includes producing a three-dimensional image of the object using data with the at least a portion of the ultrasound propagation arrangement in different positions with respect to the object.

In general, in another aspect, the invention provides an ultrasound system including a transmitting array of ultrasound energy transducers, a receiving array of ultrasound energy transducers, a controller coupled to the transmitting array and the receiving array and configured to transmit first indicia toward the transmitting array to cause the transmitting array to transmit ultrasound energy toward a focal region containing an object, receive second indicia from the receiving array, the receiving array being configured to transduce received ultrasound energy into the second indicia, analyze the second indicia to determine magnitude and phase of the received ultrasound energy, and use the determined magnitude and phase of the received ultrasound energy to mathematically back propagate the received ultrasound energy to a plane of the focal region and object.

Implementations of the invention may include one or more of the following features. The controller is further configured to determine a shape of the object using the back-propagated ultrasound energy and knowledge of the ultrasound energy propagated from the propagation arrangement. To determine the shape the controller is configured to compare third indicia of the back-propagated ultrasound energy at the plane with fourth indicia of the propagated ultrasound energy at the plane of the focal region unperturbed by the object, and iterate an estimate of the object until a relationship between the third indicia and the fourth indicia meets at least one criterion. The system further includes a positioner coupled to the controller, the transmitting array and the receiving array, the positioner being configured to position the transmitting array to help focus the transmitted ultrasound energy at the object and to position the receiving array to receive ultrasound energy transmitted by the transmitting array. The positioner is further configured to move the transmitting and receiving arrays about the object. The system further includes multiple phase shifters and amplifiers coupled to respective ones of the ultrasound energy transducers of the transmitting array, wherein the first indicia indicate respective phase shifts and amplification amounts for signals corresponding to the ultrasound energy transducers of the transmitting array.

Various aspects of the invention may provide one or more of the following advantages. Objects one order of magnitude smaller than the imaging wavelength may be resolved. Taking advantage of this reduced wavelength, high-resolution imaging can be achieved with significantly greater penetration depth, e.g., several centimeters, than using prior techniques. Aspects of the invention can be applied to a wide variety of clinical, in vivo, and non-destructive testing situations, allowing imaging unattainable with previous techniques.

These and other advantages of the invention, along with the invention itself, will be more fully understood after a review of the following figures, detailed description, and claims.

### BRIEF DESCRIPTION OF THE FIGURES

FIG. 1 is a schematic diagram of a superresolution ultrasound imaging system.

FIG. 2 is a block flow diagram of a process of performing superresolution ultrasound imaging using the system shown in FIG. 1.

FIGS. 3A-3F are image spectrums and images for an idealized Gaussian field (3A-3B), reconstructed images without superresolution (3C-3D), and with superresolution (3E-3F).

FIGS. 4A-4C are normalized plots of full spectrum, band-limited back-projected, and band-limited superresolved signals, respectively, deconvolved from a Gaussian input signal.

FIGS. 5A-5C are normalized plots of full spectrum, band-limited back-projected, and band-limited superresolved signals, respectively, deconvolved from a 1 MHz step-shaped beam.

FIGS. 6A-6F are image spectrums and image plots of full spectrum, band-limited back-projected, and band-limited superresolved signals, respectively, for a 1 MHz step-shaped beam.

FIG. 7 is an intensity vs. distance diagram showing plots of on-axis projections with and without a nylon wire present.

FIGS. 8A-8B are images of back projections in the x-z plane without and with the nylon wire present.

FIGS. 8C-8D are images of back projections in the y-z plane without and with the nylon wire present.

FIGS. 9A-9C are back-projected x-z plane images before the wire was present (9A), with the wire present but without applying superresolution (9B), and with the wire present and applying superresolution (9C).

FIGS. 10A-10C are back-projected y-z plane images before a human hair was present (10A), with the hair present but without applying superresolution (10B), and with the hair present and applying superresolution (1° C.).

FIG. 11 is a graph showing the difference between the spectra produced by an image and candidate images containing different object positions and widths.

FIGS. 12A-12B are graphs of actual width and location of an object along with calculated width and location determined using two different techniques as a function of increasing noise relative to signal level.

### DETAILED DESCRIPTION OF PREFERRED EMBODIMENTS

Embodiments of the invention provide techniques for in vivo imaging at sub-millimeter resolution. Frequencies, e.g. of one order of magnitude smaller than previously reported methods, or even lower, could be used. A combination of phase-contrast imaging, angular spectral decomposition, and an innovative superresolution reconstruction technique is used. Ultrasound is transmitted to an object that perturbs the incident waves. Beyond the object, the transmitted waves are measured in amplitude and phase. Using this information, the measured waves are back-propagated to the object and compared to information derived from a priori knowledge of the unperturbed waves. From this comparison, sources of the perturbed waves are determined that, preferably closely, approximate the object.

Embodiments of the invention could have immediate application in numerous areas. For example, embodiments of the invention could be used for detecting acoustic properties that are not visible optically such as dynamic changes that induce a change in sound speed. Examples of such changes include breast tumor imaging, internal temperature monitoring and blood flow measurement. Additionally, embodiments of the invention could have application in complementing the wide range of areas where very high frequency ultrasound is being investigated, such as vascular imaging, skin imaging, genomics, and disease modeling in rodents.

Embodiments of the invention provide for superresolution imaging for the recovery of spatial frequencies above the bandwidth that would be propagated by a single source beam to an image plane. This reconstruction is used for far-field waves, using the fact that propagated spatial information at spatial frequencies below the diffraction limit is not independent of the information above the frequency cutoff. Image reconstruction is performed using certain a priori information about the image source.

Ultrasound's superior beamshape control and phase detectability are used to implement embodiments of the invention. Objects located entirely within an ultrasound focus, over a field of view equal to the focal area, can be imaged while simultaneously providing high phase sensitivity along the ultrasound beampath. Ultrasound can provide additional spatial frequency information by passing multiple beamshapes through the imaged region, each with its own unique k-space spectrum. The beamshapes could be individually analyzed to produce the maximum likelihood of a given image plane. For example, several candidate images may be produced and the candidate with a spatial-frequency spectrum most closely matching that of the measured image (within a known part of the spectrum) will be selected as the true image. Furthermore, combining phase-contrast transmission imaging with wavevector-frequency domain planar projection may improve the accurate identification of the object plane and provide sensitivity along the axis of propagation.

Embodiments of the invention may provide for localized or time dependent distortions, including those that occur due to temperature changes, changes in blood flow, or the introduction of a contrast agent, to be imaged and quantified. Imaging thermal variation with phase contrast transmission ultrasound may achieve a higher signal to noise ratio than backscattered ultrasound, possibly due to the phase contrast method's strong phase sensitivity versus the low reflection coefficient caused by temperature changes. Embodiments of the invention numerically back-propagate the measured signal, or series of signals to planes close to the image plane and reconstruct the wavevector space in this area (volume), using the propagated planes as integral projections. This band-limited information is compared with information obtained using a priori knowledge of the source beam(s).

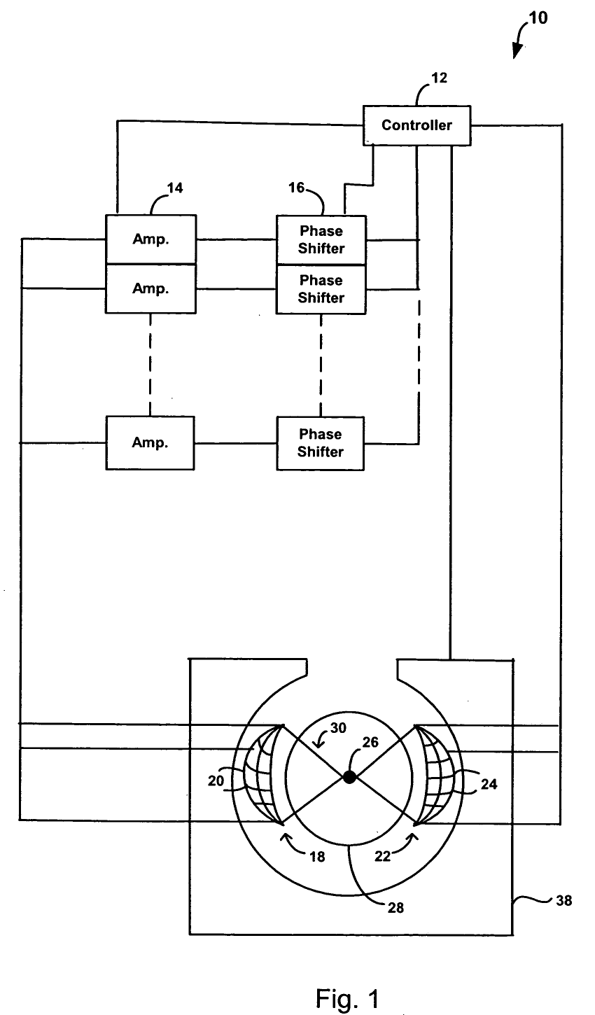

Referring to FIG. 1, a system 10 for superresolution imaging includes a controller 12, a set of amplifiers 14, a set of phase shifters 16, a transmitter phased array 18 of ultrasound transducers 20, and a receiver array 22 of ultrasound transducers 24. The system 10 is, as shown, for use in imaging an object 26 (e.g., a tumor, blood vessel, etc.) of a subject 28 (e.g., a human patient). The system 10 is configured to provide information about objects that are significantly smaller than the wavelength of the ultrasound provided by the array 18.

The controller 12 is logic that may be provided by software, hardware, firmware, hardwiring, or combinations of any of these. For example, the controller 12 can be a general purpose, or special purpose, digital data processor programmed with software in a conventional manner in order to provide the various signals and perform various functions discussed, although other configurations may be used.

The controller 12 is configured to cause the array 18 to transmit ultrasound energy into the subject 28, focused at the object 26, to the receiving array 22. The controller 12 sends imaging data signals to the phase shifters 16 to be phase shifted, amplified, and transmitted into the subject 28. The controller 12 also sends control signals to the amplifiers 14 and phase shifters 16 to control how much the imaging data signals for the individual transducers 20 are amplified and phase shifted. The phase shifters 16 are configured to provide independent output signals to the amplifiers 14 by altering or adjusting the phase of the incoming signals from the controller 12 by respective phase shift factors. The phase shifters 16 provide, e.g., approximately 1 degree precision (8-bit resolution, although lower phase resolution may be adequate for many applications). The amplifiers 14 are configured to amplify the signals from the phase shifters 16 and to provide the amplified signals to the transducer elements 20 through connections, e.g., coaxial cables, individually connecting the amplifiers 14 and the transducer elements 20.

The array 18 is configured to receive the amplified, phase-shifted imaging signals and convert them into ultrasound energy and propagate the ultrasound into the subject 28. The propagated energy forms an incident beam 30 of ultrasound that is focused at the object 26. The energy passes through and is perturbed by the object 26 and emerges from the object 26 (with some portions possibly passing around/unperturbed by the object 26) as an exit beam 32. The receiving array 22 is positioned to receive the exit beam 32 and is configured to transduce the received energy and provide corresponding receiver signals to the controller 12 indicative of the amplitudes and phases of the portions of the exit beam 32 received by the individual transducers 24.

The controller 12 is configured to process the receiver signals to obtain an image of the object 26. In order to obtain the image, the controller 12 mathematically back-propagates the received energy using the phase and amplitude information of the received ultrasound energy. The received waves are back-propagated to, or nearly to, the location of the object 26 and the back-propagated waves are compared to information derived from a priori knowledge of the focused beam 30 at the object's location. This information is preferably the input beam 30 perturbed by a function representing an estimate of the object 26. From the comparison, the controller 12 can determine the function/object estimate that approximates the back-propagated data. The controller 12 is configured to translate this function/estimate into an image of the object 26. The object can be significantly smaller than the wavelength of the ultrasound transmitted by the array 18. The image produced by the controller 12 is preferably in a two-dimensional image plane over a reasonably wide range of image intensities.

The system 10 may further include a positioner 38 under the control of the controller 12. The positioner 38 is configured to respond to instructions/signals from the controller 12 to position the transmitter array 18 and the receiver array 22. Preferably, the positioner can lock the arrays 18, 22 into place, and can also rotate or otherwise move the arrays 18, 22 about the object 26. This movement is preferably in unison, and coordinated with the phase shifts of the transducers 20 such that the transmitted ultrasound will be focused at the object 26 and received by the receiver array 22 as the arrays 18, 22 are moved. Thus, the controller 12 coordinates the phase shifts provided by the phase shifters 16 and the movements of the arrays 18, 22 as implemented by the positioner 38 under the guidance/control of the controller 12. While the positioner 38 is shown as affecting the positions of the arrays 18, 22 only, the positioner 38 could also affect the position and/or orientation of other parts of the system 10, such as the phase shifters 16 and/or amplifiers 18, particularly if these devices are affixed to the transmitter array 18. Further, configurations other than the exemplary, simplified configuration of the positioner 38 shown may be used, e.g., configurations that form a complete loop around the subject 28. The positioner 38 can rotate the arrays 18, 22 about the object 26 to provide different incident angles of the incident beam 30 upon the object 26, e.g., to help the controller 12 determine three-dimensional images of the object 26.

Theory Implemented by the Controller

The following provides theoretical background for the processing performed by the controller 12. The following equations and theory assume noiseless propagation of the ultrasound, although experimental measurements discussed below were performed to illustrate the invention's ability to operate in a noisy environment.

For illustrating the theory, a harmonic, localized, ultrasonic wave in a linear homogeneous medium, propagating along the Cartesian z-axis is considered. By the principles of Fourier spectral wave decomposition, the acoustic pressure field at the interface is given by the convolution integral
p(x)=h(x)\mathring{x}p₀(x) (1)
where p is the acoustic pressure along x in the acoustic far field p₀ is the pressure at the imaging point, and h is the acoustic transfer function between z₁ and z₀. The ability to reconstruct p₀ in terms of the spatial Fourier transform with respect to x, Eq. (1) becomes
P(k)=H(k)P₀(k). (2)

The insertion of the object 26 represented by a function f(x) contained entirely within the incident beam 30 is considered so that the field becomes f(x)p₀(x) after propagating through the object 26. The field at the image point becomes:
P(k)=H(k)[F(k)\mathring{x}P₀(k)]+N(k) (3)
where k is a spatial frequency and N is signal noise. In the absence of noise, the ability to reconstruct the object 26 at z₀, given the image P, is limited by the cutoff spatial frequency, which serves as a low pass filter. Following an argument outlined by Hunt (Super-Resolution of Imagery: Understanding the Theoretical Basis for the Recovery of Spatial Frequencies Beyond the Diffraction Limit. In Proceedings of Information Decision and Control 99243-248), using the object spectrum, Eq. (3), and the definition of the convolution integral, the high frequency components of F₂ will affect the image point P at spatial frequencies below the cutoff frequency. The superresolution algorithm infers the object shape, location, and intensity based on this partial amount of information.

It may be assumed that both the undisturbed beam P₀ and the transfer function H are known for all k by a priori measurement of the incident beam 30 at z. Superresolution images, with the information at P, are a result of the higher frequency information convolved into the signal. The successfulness of reconstructing the object F is dependent on the ability to utilize this information. In the context of an inverse problem, the task becomes one of determining (preferably optimizing) the likelihood of an estimated value for F over all k given P₀ and a band limited P. This could, in theory, be performed using a minimization procedure, such as a least squares method. Related procedures have been described in optics, but there are several differences here. First, ultrasound phase information is easily measured, facilitating back-projecting the image to the object plane. Second, most optical methods only consider the localization of the object 26 and not the source beam 30, i.e., p₀ₙ in Eq. (1) is a step function. In contrast, ultrasound allows this beam 30 to be modified by different transducer geometries. Third, using phased arrays a series of different source functions p₀ₙ can be formed, providing additional spatial information.

Using this third difference between ultrasound and optics, significant additional information about the spectrum may be retrieved by creating a series of N known beam shapes:
Pₙ(k)=H(k)[F(k)\mathring{x}P₀ₙ(k)]+Nₙ(k). (4)

The object F, however, remains the same with varying P₀ₙ. The final image spectrum may be determined by selecting a superresolved image for each beam shape and either combining these images (e.g., by averaging or another method) or choosing among them using any of a number of statistical criteria (e.g., mode or other method). Equation (4) addresses the problem of estimating the spectrum in an ideal case. The ability to recover a real object depends, however, not only on noise, but also on the accuracy of the estimation of P₀ₙ in situ, although it is believed that this recovery is possible.

The method outlined above can enhance object reconstruction limits in the imaging plane, but is not intended for enhancement along the propagation direction. For this reason, a planar projection method is also used that back-propagates the acoustic pressure from the image plane. The projection method is phase sensitive, and can detect phase shifts far smaller than one wavelength. The backward propagation may be performed using a wavevector-space planar projection approach, and/or using other acoustic propagation techniques. The use of wavevector-time domain backward projection, for both transmission and backscattered data is well established. The present reconstruction is performed with a lowpass spatial frequency with a cutoff frequency of k≦ω/c. This method applies a transfer function in wavevector-frequency space to project the signal at the receiver 22 to a plane directly beyond the heated region. The phase shift at a given time can be determined by propagating P(k, z) and P₀(k, z) from zᵣ to z₀ using a transfer function, where P₀ is the a priori measured field.

Operation

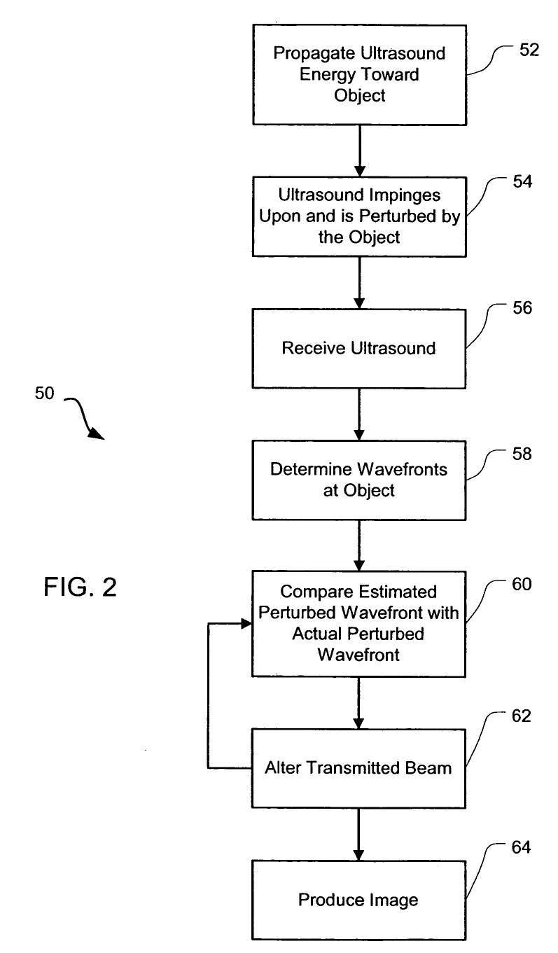

In operation, referring to FIG. 2, with further reference to FIG. 1, a process 50 for superresolution imaging the object 26 using the system 10 includes the stages shown. The process 50, however, is exemplary only and not limiting. The process 50 can be altered, e.g., by having stages added, removed, or rearranged.

At stage 52, ultrasound energy is propagated toward the object 26. The controller 12 sends data signals to the amplifiers 14 and control signals to both the amplifiers 14 and the phase shifters 16 to instruct the devices 14, 16 how to alter the data signals. The altered data signals are passed to the transducers 20 of the transmitting array 18, transduced into ultrasound energy, and propagated toward the object 26. The configuration of the array 18 combined with the phases of the emitted signals from the respective transducers 20 cause the propagated energy to focus at the object 26.

At stage 54, the propagated ultrasound energy impinges upon, and is perturbed by, the object 26. Energy incident upon the object 26 is perturbed, including being absorbed, reflected, and/or refracted. If the object 26 is smaller than the focal region of the propagated energy, then some energy will pass by the object 26 without being perturbed.

At stage 56, ultrasound energy is received by the receiver array 22. Energy that passes by or through the object 26 is received by the array 22 and converted into, e.g., electrical, signals by the transducers 24. These signals are sent to the controller 12 for processing.

At stage 58, the controller 12 determines wavefronts of ultrasound energy at the object 26. The controller 12 processes the received signals to back propagate the received wavefront to a plane of the object 26. The controller 12 manipulates the phase and amplitude of the ultrasound energy measured by the transducers 24 in accordance with the theory provided above to determine a wavefront in a plane of the object 26. Further, the controller 12 uses the known amplitude and phase of the energy transmitted by the transducers 20 of the transmitting array 18 to mathematically forward propagate the transmitted ultrasound to determine a wavefront of the propagated energy at the same plane, assuming that the object 26 is not present.

At stage 60, the controller 12 compares a perturbation of the forward-propagated wavefront with the back-propagated wavefront and iterates an estimate of the shape of the object 26 that would perturb the forward-propagated wavefront to resemble the back-propagated wavefront. The controller 12 alters the forward-propagated wavefront using an estimate of the object 26 and compares the altered forward-propagated wavefront and the back-propagated wavefront. If the comparison meets a predetermined criterion or criteria, e.g., least-squares minimization, then the process 50 proceeds to stage 62. Otherwise, the controller 12 iterates its estimate of the object, re-computes the perturbed forward-propagated wavefront, and compares the re-computed wavefront against the back-propagated wavefront. This continues until the criterion/criteria is/are met, or further iterations are stopped (e.g., due to convergence being deemed impossible, unlikely, or not justified by time/cost), at which point the process 50 proceeds to stage 62.

At stage 62, the transmitted beam 30 is altered. This altering may be in the form of different phase shifts and/or amplifications being applied by the amplifiers 14 and/or phase shifters 16 (whether this redirects the beam 30 and/or alters its shape), and/or by physically moving the arrays 18, 22. The physical movement of the arrays 18, 22 is actuated by the controller 12 sending control signals to the positioner 38 to effect the desired movement. The process 50 returns to stage 60 for further iterations of the estimated object shape and/or iterations of the object's shape in a plane different than that/those previously analyzed.

At stage 64, the controller 12 uses the determined object's shape (i.e., the last estimate when the convergence criterion/a was/were met or iterations were otherwise stopped) to produce an image of the object 26. The object 26 is represented by the determined estimate of its shape. The image is two-dimensional if only one plane was analyzed, but is preferably three-dimensional if the arrays 18, 22 were moved about the object 26.

Experimental Results

Numeric Data

To evaluate the capability of the superresolution concept applied toward ultrasound imaging, a noiseless 1-dimensional simulation was set up, seeking to resolve a 0.2 mm object imbedded in a homogeneous tissue (c=1560 m/s) using a 1 MHz imaging beam 30. Two incident beams 30, one with a Gaussian-shaped amplitude profile (FWHM=2 mm) and the other with a step profile (width=4 mm) were separately considered, representing two significantly different spatial (angular) spectrums. The data were processed using an optimization routine that produced a candidate value for the object function, and sought to minimize the difference in the standard deviation between the candidate and measured function F(k) within the known part of the spectrum k<K. To perform this minimization, a surface was created representing this difference as a function of position and object size and the surface minimum was then chosen.

The nature of the reconstruction method required particular attention to noise, as it relied on subtle changes in the field. With this in mind, the effects of noise in the data were examined, paying particular attention to how it distorted the difference surface. Broadband random noise of a controlled level was created with a pseudo-random number generator. This noise was added linearly to the measured field given by Eq. (3), causing distortion of the amplitude and phase of the signal. Noise levels between 0 and 30% of the peak signal level were examined for the Gaussian signal. The field reconstruction was then performed and compared with the actual object size and location.

Laboratory Measurement

Experiments were performed to obtain superresolution images of three sizes of objects. The objects images were 0.6 mm and 0.3 mm diameter nylon wires and a human hair (˜0.03 mm diameter). Successful imaging was determined by comparing back-projection images with and without applying superresolution and measurements of the apparent object width. Wires were deliberately chosen as the imaging objects so that a 1-dimensional algorithm could be used to simplify calculations. The algorithm was was repeatedly applied along the direction perpendicular to the wire, so that the reconstruction of the two-dimensional image has superresolution applied only in one direction.

All measurements were made in a tank filled with degassed and deionized water. Inner walls of the tank were covered with rubber to prevent reflections. A pulsed sine waveform was generated by a 100 MHz Synthesized Arbitrary Waveform Generator (Wavetek, model 395). The signal was sent to an RF Power Amplifier (ENI Technology, Inc. of Rochester, N.Y., model A150) and then to a focused transducer. The waveform generator and the RF power amplifier remained the same during all of the measurements. Two different focused transducers were used: a single element transducer with driving frequency of 1.05 MHz and a 0.9 MHz driven at its 5^{th} harmonic of 4.7 MHz.

Signals were measured with a scanned hydrophone connected to a computer-controlled Parker 3D stepping motor-guided positioning system. An in-house manufactured 0.2 mm hydrophone (ICBM01180102) was used for measurements at 1.05 MHz and a 0.075 mm polyvinylidene difluoride (PVDF) hydrophone (Precision Acoustics of Dorchester, UK, model SNS04) for measurements at 4.7 MHz. When using the PVDF hydrophone the signal was sent through a submersible preamplifier (Precision Acoustics Ltd. model W210249). Both hydrophone signals were processed by amplifiers (Premeable Instruments, model 1820 and LeCroy Corporation of Chestnut Ridge, NY, model DA1820A) and the time trace was recorded by a Tektronix oscilloscope (Tektronix, Inc. of Beaverton, OR, models TDS 380, TDS 3012s).

Image reconstruction was implemented with a routine in Matlab®. Before reconstruction, an autocorrelation function was applied between two images, one with and one without a wire. The autocorrelation corrected for slight motion of the field caused by thermally induced drifting or slight motions of the transducer. Object size was determined by measuring full width at half maximum (FWHM) from the back-projected image reconstruction.

Numeric Study

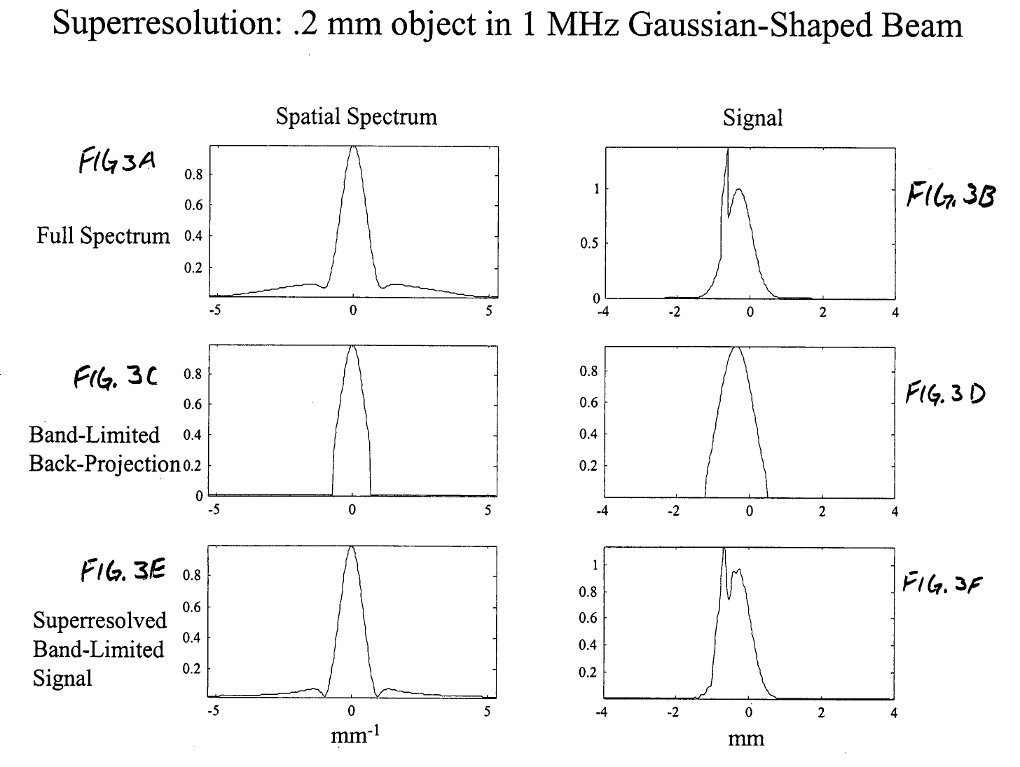

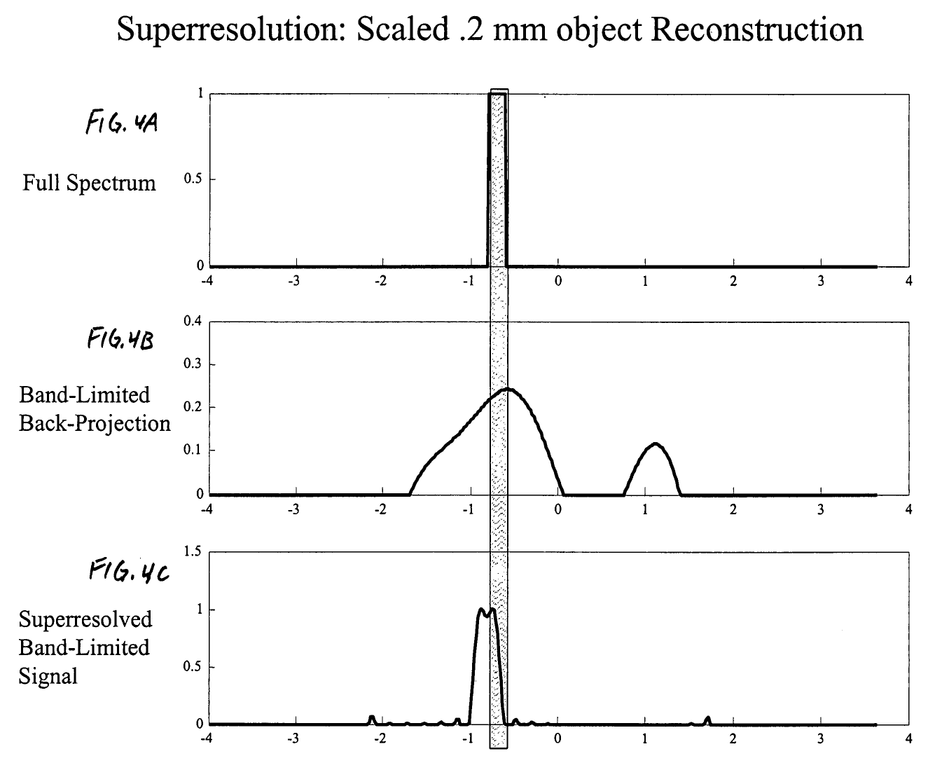

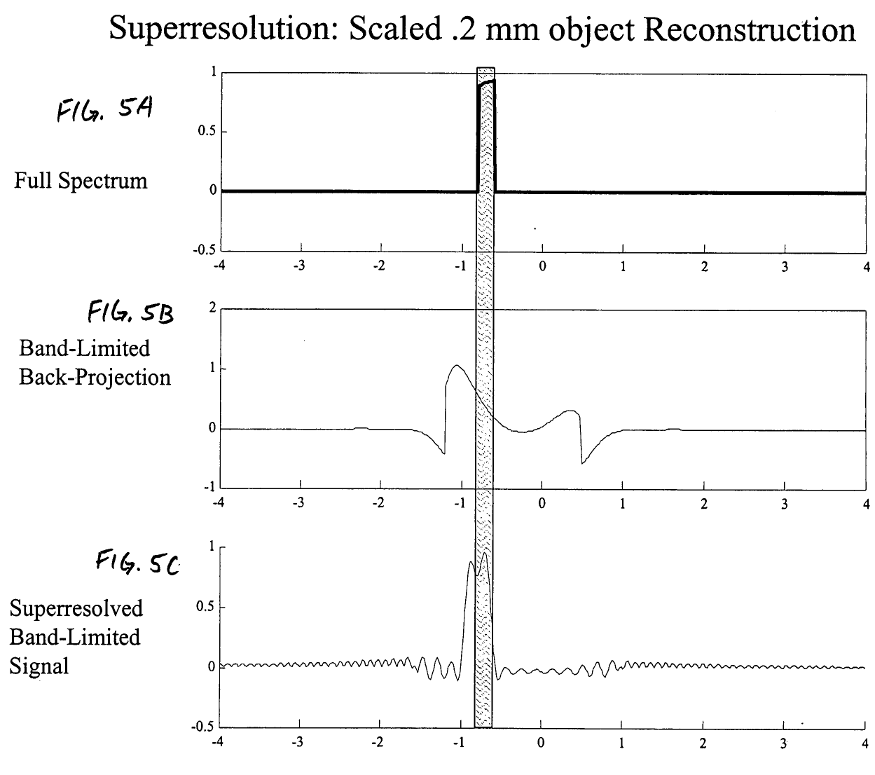

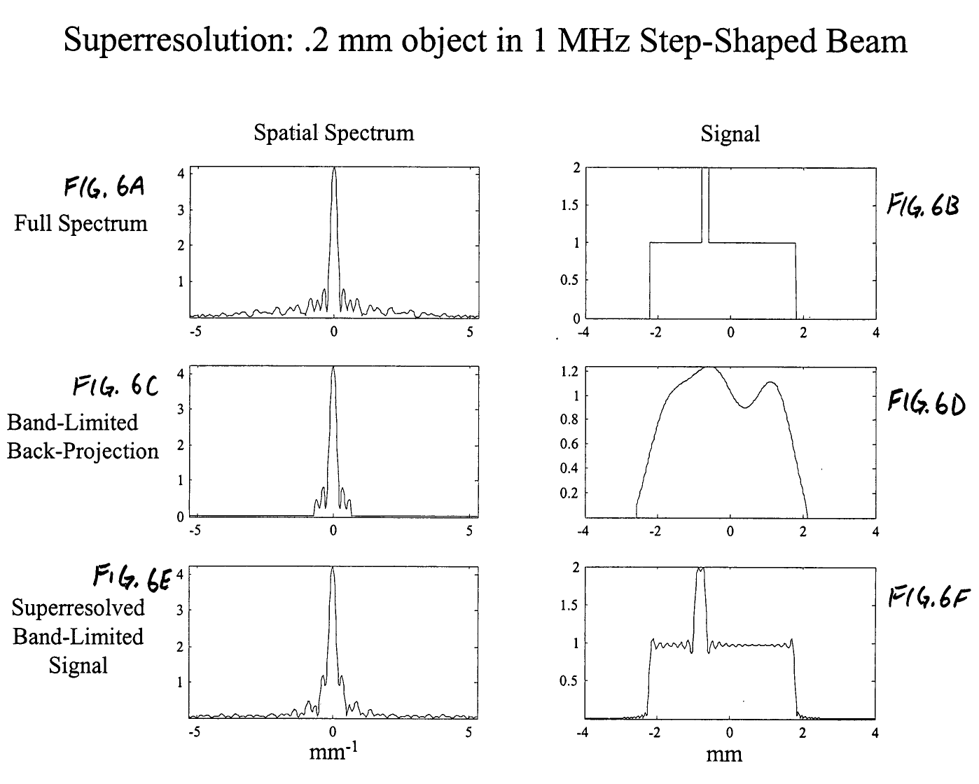

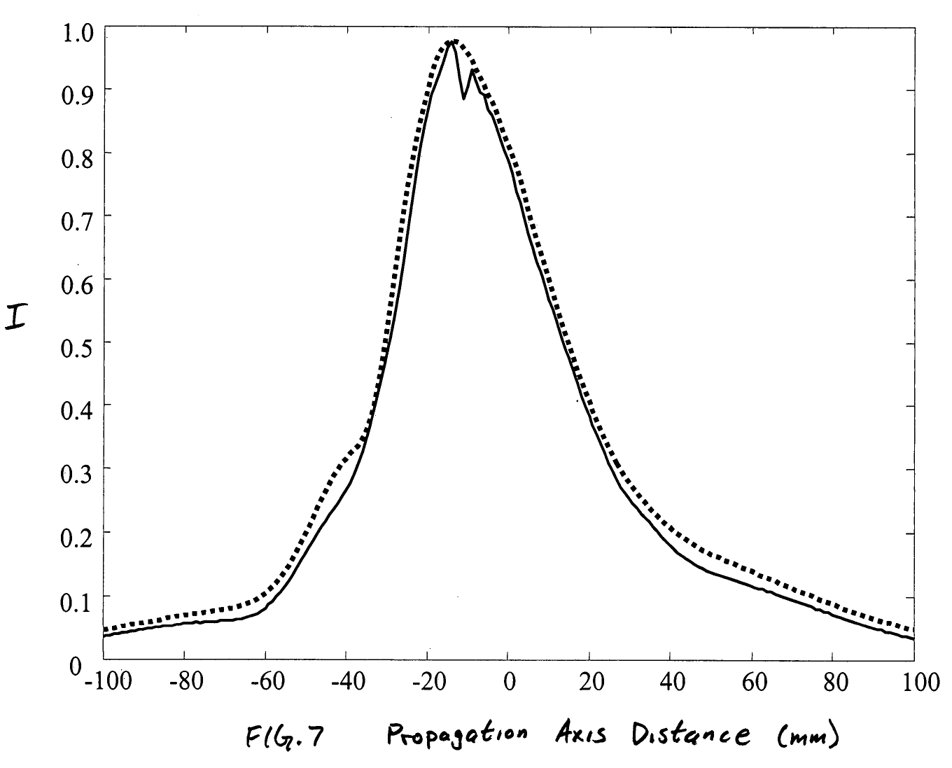

FIGS. 3A-3B show the idealized (noiseless) simulated Gaussian-shaped field directly after passing through the object plane, without and with an object present respectively. The image spectrum (3A) and actual image (3B) are both given. For illustration, the object function is simulated as a net signal gain, however the argument readily follows to cases where the object causes attenuation and/or phase shift. Specifically, phase gain is described below. FIGS. 3C-3D show the reconstructed image without superresolution compensation, when the acoustic image plane is located more than a few wavelengths from the object 26. When the difference surface was examined, a global minimum (i.e., the center of multiple minima induced by noise) was found and selected as the object size and location. FIGS. 3E-3F show the data reconstructed using the superresolution provided by the controller 12. Partial reconstruction of the higher spatial components is evident in the spatial frequency plot (3E). The object 26 was deconvolved from the source beam 30, resulting in the normalized object identifications shown in FIGS. 4A-4C. As shown in FIG. 4B, without superresolution the object 26 produces an artifact that is indiscemibly related to the actual object 26. As shown in FIG. 4C, the superresolution reconstruction produces improvement in both object localization and spatial dimensions. Similarly, FIG. 5A shows the stepped field directly after passing through the object plane. FIG. 5B shows the reconstructed image without superresolution compensation, and FIG. 5C shows the same data reconstructed using the superresolution algorithm performed by the controller 12. As in the case with the Gaussian beam, the algorithm again successfully localized a stepped object, which contained a broadband spatial spectrum (FIG. 5A). FIG. 5B shows the reconstructed image without superresolution compensation, and FIG. 5C shows the same data using the superresolution algorithm.

The primary affect of noise on the difference surface was found to be an overall gradient reduction or “flattening” of a region on the surface (FIG. 11), in many cases creating more than one global minimum. These reduction were both localized and centered around the minima present without noise suggesting that image recovery may be possible, even in the presence of a significant level of noise. In this preliminary study two possible recovery methods were considered. The first technique found the 20 lowest values on the surface. The centermost position of these points was determined in a manner similar to a center-of-mass (c.o.m.) calculation:

$$\frac{{\sum }_{n = 1}^{N} {D}_{n} {r}_{n}}{{\sum }_{n = 1}^{N} {D}_{n}} \qquad ( 4 )$$

where D is the difference values at surface position r. In this case r represents a vector with dimensions expressing object width and location, respectively. This central value was selected to be the true object. The calculation in Eq. (5) readily generalizes to higher dimensions. The second technique selected a position value by finding the minimum along each position line (FIG. 11) and selecting the mean of the selected locations. While holding the location constant, the minimum width at this position was identified. Results using both techniques are shown as a function of noise in FIG. 12. The second technique appeared to be less sensitive to noise. There are, however, numerous optimization approaches and the techniques described are exemplary only and provided to demostrate that recovery is possible in the presence of noise. Other algorithms, including more sophisticated algorithms, will likely further reduce distortion in the presence of noise. In all cases examined, however, an object was detected.

Laboratory-Acquired Images

To investigate the feasibility of applying superresolution to authentic ultrasound signals, a total of six samples were reconstructed. Four samples were examined with 0.34 MHz nylon wire and a single sample each of 0.60 mm wire and 0.03 mm human hair. The 1.05 MHz transducer was used with the nylon wire and the 4.70 MHz transducer was used with the hair.

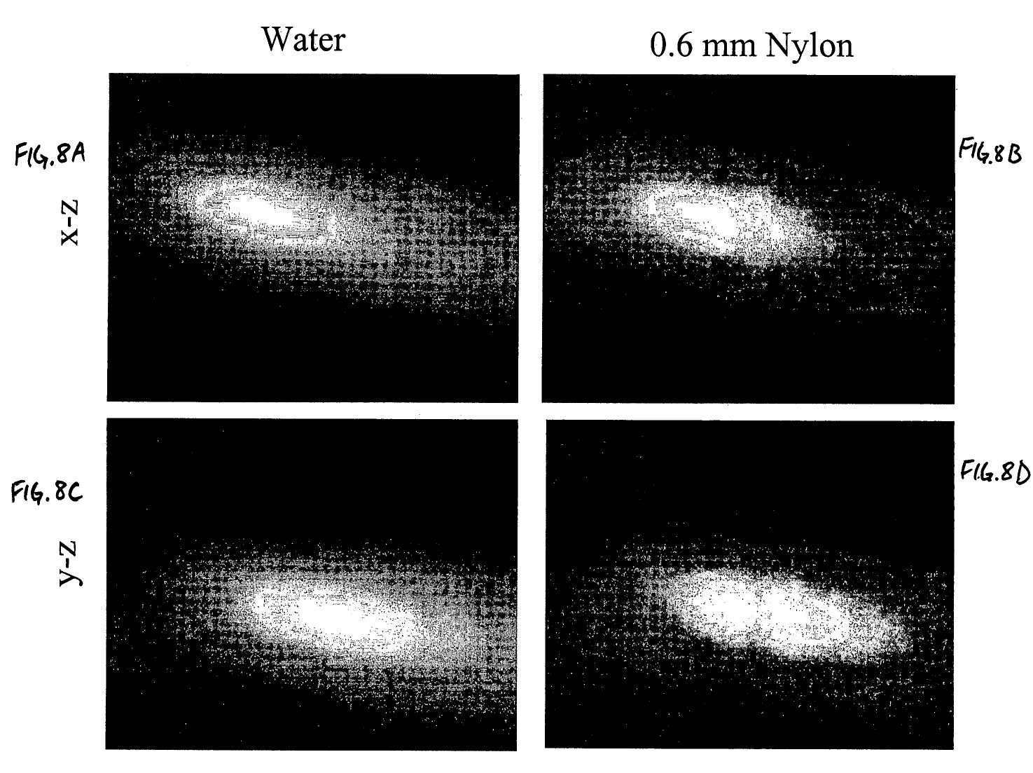

Initially, axial back projections were performed to examine the evolution of the field along the axis of propagation. These back projection were highly sensitive to the presence of the wire, causing a reduction of image intensity near the object plane. Thus, these images helped to identify the location object plane on the propagation axis. FIG. 7 shows the on-axis projection before and after the 0.6 mm nylon wire was inserted. In this case there was a clearly visible reduction of the intensity at z=−11 mm. Using this information, high-resolution axial back projections were performed in the x-z plane, perpendicular to the wire near z=−11 mm. These projections helped to identify the approximate location of the wire on the x-axis, when compared to the same signal without a wire (FIGS. 8A-8B). Similarly, high-resolution axial back projections were performed in the y-z plane, perpendicular to the wire near the x-axis intersection of the wire. These projections helped to identify the approximate location of the wire along the y-axis (FIGS. 8C-8D).

The identified location of the image plane was used to produce the image. The signal was back projected and images were constructed both with and without the superresolution algorithm.

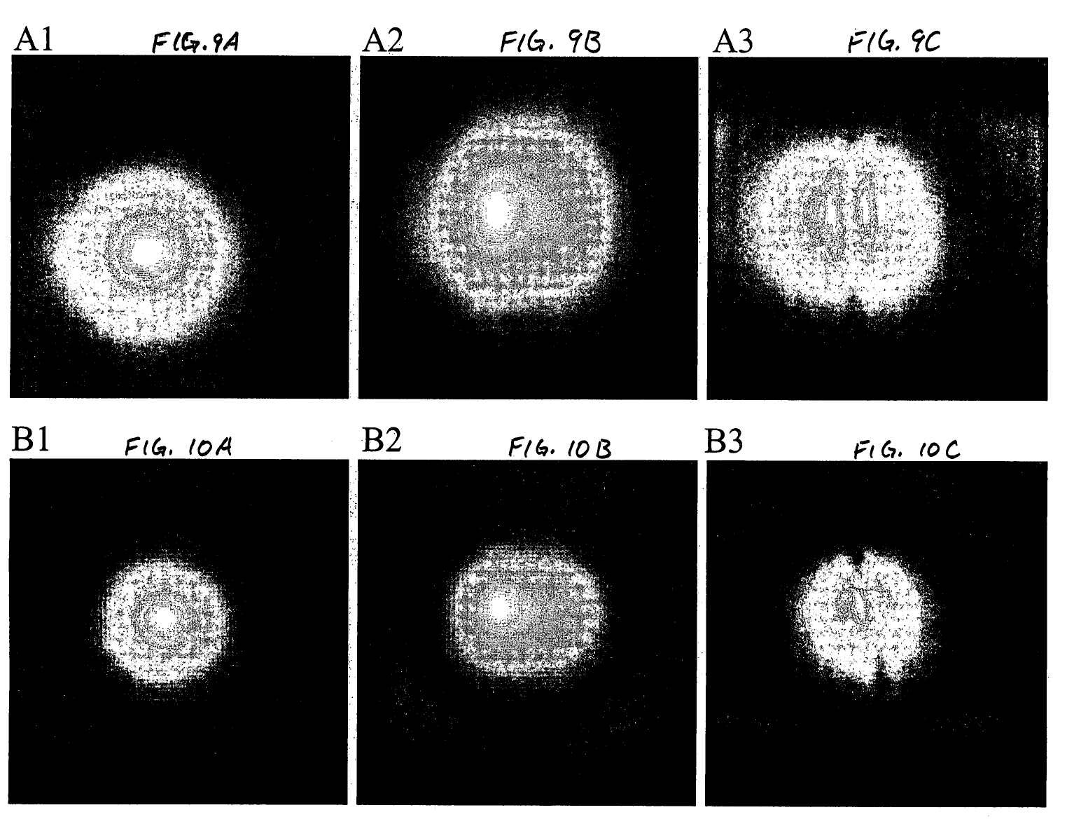

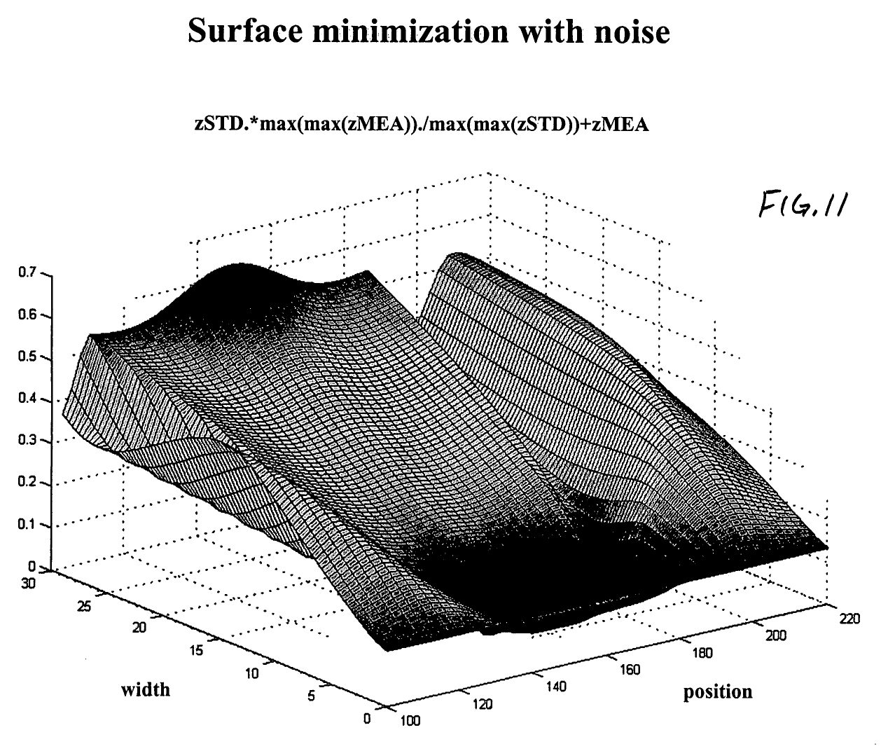

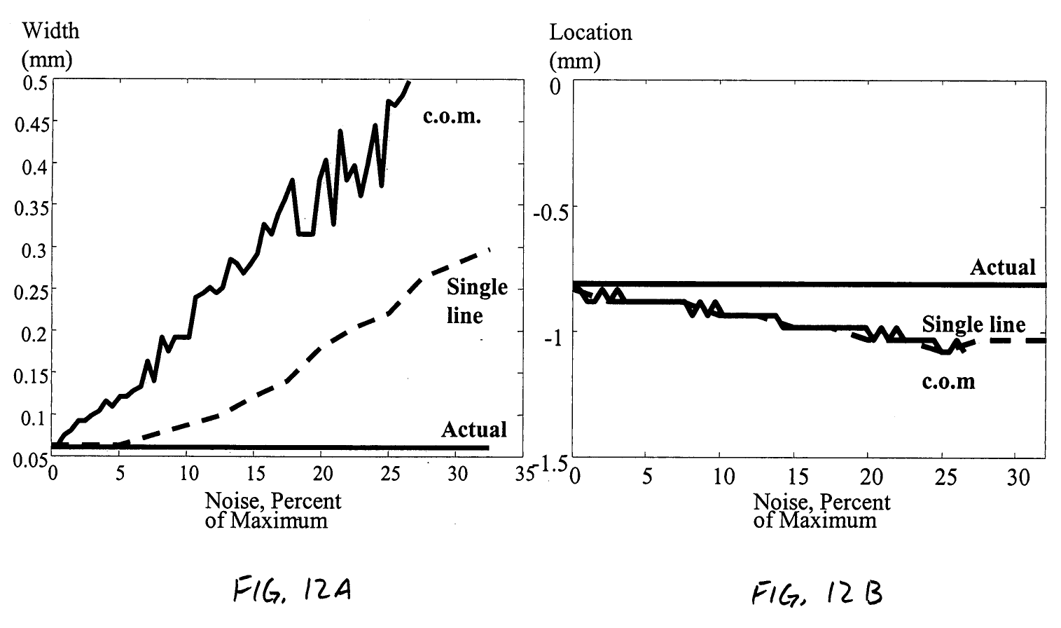

This procedure was applied to the 0.60 mm wire, three cases with the 0.34 mm wire and one case with the 0.03 mm hair. The algorithm successfully identified the samples in each of these cases. The ability of the algorithm to identify the actual width of the object was considered after the reconstruction. A summary of the measurements is presented in Table 1, showing that the wire (or hair) width was accurate to within a 15% difference in each case where the sample was detected, the greater accuracy occurring with the smaller objects, which is the region where superresolution is designed to be applied. In the case of the 0.60 mm wire, however, measurements were made on only 129 out of 220 image lines (59%), with a failure to find the image in the remaining 91 lines Comparison of images before (FIG. 9A) and after the wire was inserted (FIG. 9B) indicated that the field experienced some distortion, but did not produce any sign of the wire. The same image with superresolution applied (FIG. 9C), however, clearly showed an object through the focal area. Similarly, FIGS. 10A-C illustrate considerable image improvement experienced with superresolution applied to a human hair image.

TABLE 1

| Frequency | Wire/Hair | Measured Thickness | Difference |
|---|---|---|---|
| (MHz) | Thickness (mm) | (mm) | (%) |
| 1.05 | 0.60 | 0.44 | 15 |
| 1.05 | 0.34 | 0.29 | 7.9 |
| 1.05 | 0.34 | 0.35 | 1.5 |
| 1.05 | 0.34 | 0.35 | 1.5 |
| 1.05 | 0.34 | None detected | N/A |
| 4.70 | 0.03 | 0.03 | 0 |

Applications

The techniques discussed can used for ultrasound imaging and microscopy, that is expected to provide greater penetration depths and provide a valuable assessment of the ability of superresolved ultrasound to detect features in soft tissues, in vivo. The techniques could offer considerable benefits to both laboratory research and clinical diagnostics. An exemplary application for the phase contrast superresolution method is breast tumor detection. Mammography screening has been shown to reduce cancer mortality rates, bit it intrinsically increases the risk of radiation-induced cancer, sustains a substantial number of false positive reads, and experiences a reduced success rate with the dense fibroglandular tissue commonly found in women under 40. Phase contrast superresolution could offer a non-ionizing imaging method that could operate in dense tissues. Furthermore, such a system could be compact and be very low cost, allowing it to be used routinely and making it widely available to clinics worldwide that presently rely on clinical breast examination (CBE) alone.

A large body of other clinical uses include clinical diagnosis, sensing tissue morphological changes, monitoring of disease progression, temperature monitoring, and blood vessels imaging. Embryo development in chickens could potentially be extended to imaging within the intact egg, and in utero imaging could be possible in mice. These uses could potentially be expanded relative to high-frequency ultrasound to allow imaging with greater depth penetration than with high-frequency ultrasound.

The superresolution accuracy was found to be lower for the larger sized (0.6 mm) wire, and more accurate with the objects much smaller than a wavelength, which is the region where superresolution is designed to be applied. The algorithm used searched for objects in the size range from nothing up to the size of the ultrasound beamwidth. Future algorithms could limit this search area and additional beams could be passed through the region with differing beamwidths. The final image spectrum could then be determined by first selecting a superresolved image for each beam shape and then choosing among the candidates using statistical correction criteria.

With a 1-D example, an image was reconstructed of a human hair with a diameter equal to approximately 0.09 wavelengths. This result used the full complex wavefront information for reconstruction of image, which has not been used before in superresolution imaging. The use of ultrasound will allow even more advanced methods to be used for the imaging, such as use of multiple ultrasound beam shapes (both amplitude and phase spatial distribution can be controlled) to bring out a broader range of spatial frequencies, which are later combined to reconstruct images in the object plane. A larger, and more sophisticated, higher-dimensional optimisation algorithm could be used for producing images in three dimensions. The techniques discussed could have immediate application in detecting acoustic properties that are not visible with present diagnostic methods. In particular, the techniques discussed could be used to detect dynamic changes that induce a change in sound speed. Examples of such changes may include breast tumour imaging, internal temperature monitoring and blood flow measurement, as well as many in vivo laboratory applications.

### Other Embodiments

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. For example, while stage 62 of FIG. 2 may help improve accuracy and the ability to produce three-dimensional images, this stage may be skipped, e.g., if three-dimensional images are not desired, are to be determined using another technique, and/or if the accuracy provided by the process 50 without altering the phase shifts and/or amplifications is acceptable.

Further, at stage 58 of the process 50, the perturbed and un-perturbed ultrasound energy wavefronts can be determined at planes other than at the object 26. The wavefronts are determined at a common plane, but the plane need not be at the object 26. For example, the estimate of the perturbed wavefront can be forward propagated to the receiving array 22, or to any plane between the object 26 and the array 22. The received wavefront can be back-propagated to the desired plane as appropriate. Planes beyond the array 22 or before the object 26 could also be used by forward propagating the received wavefront or by propagating the energy from the array 18 to the desired plane in front of the object 26 (i.e., between the array 18 and the object 26).

1. A computer program product residing on a computer-readable medium and comprising computer-readable, computer-executable instructions for causing a computer to:
transmit first indicia for an ultrasound propagation arrangement to propagate ultrasound energy toward a focal region containing an object;
receive second indicia from a receiver positioned to receive the propagated ultrasound energy after passing at least one of by and through the object and configured to transduce the received ultrasound energy into the second indicia;
analyze the second indicia to determine magnitude and phase of the received ultrasound energy; and
use the determined magnitude and phase of the received ultrasound energy and knowledge of the ultrasound energy propagated from the propagation arrangement to mathematically propagate indicia of at least one of the received ultrasound energy and the transmitted ultrasound energy to a common location.

2. The computer program product of claim 1 further comprising instructions for causing the computer to produce a perturbed signal indicative of the transmitted ultrasound energy perturbed by an estimate of the object, wherein the instructions for causing the computer to propagate indicia are configured to cause the computer to propagate indicia of at least one of the perturbed signal and the received ultrasound energy to a common plane.

3. The computer program product of claim 2 wherein the instructions for causing the computer to propagate indicia are configured to cause the computer to back-propagate the indicia of the received ultrasound energy to a plane of the focal region and object.

4. The computer program product of claim 1 further comprising instructions for causing the computer to determine a shape of the object using the indicia of the back-propagated ultrasound energy.

5. The computer program product of claim 4 wherein the instructions for causing the computer to determine the shape comprise instructions for causing the computer to:
compare third indicia of the back-propagated ultrasound energy at the plane with fourth indicia of the perturbed signal; and
iterate the estimate of the object until a relationship between the third indicia and the fourth indicia meets at least one criterion.

6. The computer program product of claim 5 further comprising instructions for causing the computer to produce an image using the estimate of the object when the at least one criterion is met.

7. The computer program product of claim 1 further comprising instructions for causing the computer to alter the propagated ultrasound energy in at least one of phase, magnitude, and space.

8. The computer program product of claim 1 further comprising instructions for causing the computer to cause the input beam to be moved.

9. The computer program product of claim 8 wherein the instructions for causing the computer to cause the input beam to be moved cause the input beam to be electronically scanned.

10. The computer program product of claim 8 wherein the instructions for causing the computer to cause the input beam to be moved cause at least a portion of the ultrasound propagation arrangement to be moved around the object.

11. The computer program product of claim 10 further comprising instructions for causing the computer to produce a three-dimensional image of the object using data with the at least a portion of the ultrasound propagation arrangement in different positions with respect to the object.

12. A method of imaging an object, the method comprising:
transmitting first indicia for an ultrasound propagation arrangement to send ultrasound energy toward a focal region containing an object;
receiving second indicia from a receiver positioned to receive the propagated ultrasound energy after passing at least one of by and through the object and configured to transduce the received ultrasound energy into the second indicia;
analyzing the second indicia to determine magnitude and phase of the received ultrasound energy; and
using at least one of the determined magnitude and phase of the received ultrasound energy and knowledge of the sent ultrasound energy to mathematically propagate at least one of third indicia of the received ultrasound energy and fourth indicia of the sent ultrasound energy to a common location for comparison of at least one of the received ultrasound energy and the third indicia with at least one of the sent ultrasound energy and the fourth indicia.

13. The method of claim 12 wherein the third indicia are back-propagated to a plane of the focal region and object.

14. The method of claim 13 further comprising determining a shape of the object using the back-propagated third indicia and knowledge of the ultrasound energy sent from the propagation arrangement.

15. The method of claim 14 wherein determining the shape comprises:
comparing the third indicia of the back-propagated ultrasound energy at the plane with the fourth indicia of the propagated ultrasound energy at the plane of the focal region unperturbed by the object; and
iterating an estimate of the object until a relationship between the third indicia and the fourth indicia meets at least one criterion.

16. The method of claim 15 further comprising producing an image using the estimate of the object when the at least one criterion is met.

17. The method of claim 12 further comprising altering the propagated ultrasound energy in at least one of phase, magnitude, and space.

18. The method of claim 12 further comprising moving the input beam.

19. The method of claim 18 wherein moving the input beam comprises electronically scanning the input beam.

20. The method of claim 18 wherein moving the input beam comprises moving at least a portion of the ultrasound propagation arrangement around the object.

21. The method of claim 20 further comprising producing a three-dimensional image of the object using data with the at least a portion of the ultrasound propagation arrangement in different positions with respect to the object.

22. An ultrasound system comprising:
a transmitting array of ultrasound energy transducers;
a receiving array of ultrasound energy transducers;
a controller coupled to the transmitting array and the receiving array and configured to:
transmit first indicia toward the transmitting array to cause the transmitting array to transmit ultrasound energy toward a focal region containing an object;
receive second indicia from the receiving array, the receiving array being configured to transduce received ultrasound energy into the second indicia;
analyze the second indicia to determine magnitude and phase of the received ultrasound energy; and
use the determined magnitude and phase of the received ultrasound energy to mathematically back propagate the received ultrasound energy to a plane of the focal region and object.

23. The system of claim 22 wherein the controller is further configured to determine a shape of the object using the back-propagated ultrasound energy and knowledge of the ultrasound energy propagated from the propagation arrangement.

24. The system of claim 23 wherein to determine the shape the controller is configured to:
compare third indicia of the back-propagated ultrasound energy at the plane with fourth indicia of the propagated ultrasound energy at the plane of the focal region unperturbed by the object; and
iterate an estimate of the object until a relationship between the third indicia and the fourth indicia meets at least one criterion.

25. The system of claim 23 further comprising a positioner coupled to the controller, the transmitting array and the receiving array, the positioner being configured to position the transmitting array to help focus the transmitted ultrasound energy at the object and to position the receiving array to receive ultrasound energy transmitted by the transmitting array.

26. The system of claim 25 wherein the positioner is further configured to move the transmitting and receiving arrays about the object.

27. The system of claim 23 further comprising a plurality of phase shifters and amplifiers coupled to respective ones of the ultrasound energy transducers of the transmitting array, wherein the first indicia indicate respective phase shifts and amplification amounts for signals corresponding to the ultrasound energy transducers of the transmitting array.
